(19) United States
(12) Patent Application Publication
(10) Pub. No.: US 2023/0326268 A1
(43) Pub. Date: Oct. 12, 2023

(54) SYSTEM AND METHOD FOR USER-DEFINED ELECTRIC VEHICLE SUPERCAPACITOR BATTERIES

(71) Applicant: SUSTAINABLE ENERGY TECHNOLOGIES, INC., WILMINGTON, DE (US)

(72) Inventor: John Cronin, Wilmington, DE (US)

(21) Appl. No.: 18/076,266

(22) Filed: Dec. 6, 2022

Related U.S. Application Data
(60) Provisional application No. 63/286,423, filed on Dec. 6, 2021.

(51) Int. Cl. G07C 5/08; G07C 5/10

(52) U.S. Cl. CPC G07C 5/085; G07C 5/10; B60L 15/2045

(57) ABSTRACT

Disclosed herein are systems and methods for energy architecture customization. A vehicle attribute sensor measures one or more attributes of a vehicle. A user profile database stores information about a user of the vehicle. A control system with a processor and a memory selects one or more attributes of an energy storage unit to customize the energy storage unit for powering at least a propulsion mechanism of the vehicle based on the one or more attributes of the vehicle and the information about the user of the vehicle. A output interface outputs an indication of the selected one or more attributes of the energy storage unit.

### CROSS-REFERENCE TO RELATED APPLICATIONS

This application claims the benefit of U.S. Provisional Application No. 63/286,423, filed Dec. 6, 2021, for “SYSTEM AND METHOD FOR USER-DEFINED ELECTRIC VEHICLE SUPERCAPACITOR BATTERIES,” the disclosure of which is incorporated herein by reference in its entirety.

### FIELD OF THE DISCLOSURE

The present disclosure is generally related to designing a customized supercapacitor battery, companion matrix controller, and/or mobile application for a vehicle based on a profile of the vehicle and/or a profile of a user of the vehicle.

### BACKGROUND

Some vehicles, such as electric vehicles or hybrid vehicles, include energy storage units such as batteries to power components and subsystems of the vehicles. For instance, in some vehicles, power from the energy storage units is used to power propulsion mechanisms, such as motors and/or engines, that propel the vehicle. In some cases, a first vehicle may function better (e.g., more efficiently) when powered using energy storage units with a first set of properties, while a second vehicle may function better (e.g., more efficiently) when powered using energy storage units with a second set of properties. A supercapacitor is a type of capacitor that can be used as an energy storage unit.

### SUMMARY

Disclosed herein are systems and methods for energy architecture customization. A vehicle attribute sensor measures one or more attributes of a vehicle. A user profile database stores information about a user of the vehicle. A control system with a processor and a memory selects one or more attributes of an energy storage unit to customize the energy storage unit for powering at least a propulsion mechanism of the vehicle based on the one or more attributes of the vehicle and the information about the user of the vehicle. A output interface outputs an indication of the selected one or more attributes of the energy storage unit.

In an illustrative example, a system is disclosed for vehicle energy architecture customization. The system comprises: a vehicle attribute sensor that is configured to measure one or more attributes of a vehicle; a user profile database that is configured to store information about a user of the vehicle; a control system comprising a processor with access to a memory, wherein the control system is configured to select one or more attributes of an energy storage unit to customize the energy storage unit for powering at least a propulsion mechanism of the vehicle based on the one or more attributes of the vehicle and the information about the user of the vehicle; and an output interface coupled to the control system and configured to output an indication of the selected one or more attributes of the energy storage unit.

In another illustrative example, a method is disclosed for vehicle energy architecture customization. The method comprises: measuring one or more attributes of a vehicle using a vehicle attribute sensor; storing information about a user of the vehicle in a user profile database; selecting one or more attributes of an energy storage unit to customize the energy storage unit for powering at least a propulsion mechanism of the vehicle based on the one or more attributes of the vehicle and the information about the user of the vehicle; and outputting an indication of the selected one or more attributes of the energy storage unit using an output interface.

### BRIEF DESCRIPTIONS OF THE DRAWINGS

The accompanying drawings illustrate various embodiments of systems, methods, and other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a block diagram illustrating an architecture of an energy management system, according to some examples.

FIG. 2 is a flow diagram illustrating a process performed using an SC MFG base module, according to some examples.

FIG. 3 is a flow diagram illustrating a process performed using a user profile module, according to some examples.

FIG. 4 is a flow diagram illustrating a process performed using an EV profile module, according to some examples.

FIG. 5 is a flow diagram illustrating a process performed using an SC design module, according to some examples.

FIG. 6 is a flow diagram illustrating a process performed using a create SC module, according to some examples.

FIG. 7 is a flow diagram illustrating a process performed using a create SC module, according to some examples.

FIG. 8 is a flow diagram illustrating a process performed using a program SC matrix controller, according to some examples.

FIG. 9 is a flow diagram illustrating a process performed using a create SC module, according to some examples.

FIG. 10 is a block diagram illustrating use of one or more trained machine learning models of a machine learning engine to select attribute(s) of an energy storage unit to customize the energy storage unit for a vehicle based on attribute(s) of the vehicle and information about a user of the vehicle, according to some examples.

FIG. 11 is a flow diagram illustrating a process for vehicle energy architecture customization performed using a control system, according to some examples.

### DETAILED DESCRIPTION

Aspects of the present disclosure are disclosed in the following description and related figures directed to specific embodiments of the disclosure. Those of ordinary skill in the art will recognize that alternate embodiments may be devised without departing from the claims’ spirit or scope. Additionally, well-known elements of exemplary embodiments of the disclosure will not be described in detail or will be omitted so as not to obscure the relevant details of the disclosure

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the disclosure, embodiments, or disclosure do not require that all embodiments include the discussed feature, advantage, or mode of operation.

Further, many of the embodiments described herein are described in sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium. The execution of the sequence of actions enables the processor to perform the functionality described herein. Thus, the various aspects of the present disclosure may be embodied in several different forms, all of which have been contemplated to be within the scope of the claimed subject matter. In addition, for each of the embodiments described herein, the corresponding form of any such embodiments may be described herein as, for example, a computer configured to perform the described action.

Disclosed herein are systems and methods for energy architecture customization. A vehicle attribute sensor measures one or more attributes of a vehicle. A user profile database stores information about a user of the vehicle. A control system with a processor and a memory selects one or more attributes of an energy storage unit to customize the energy storage unit for powering at least a propulsion mechanism of the vehicle based on the one or more attributes of the vehicle and the information about the user of the vehicle. A output interface outputs an indication of the selected one or more attributes of the energy storage unit.

A summary of the terminology used herein is provided concerning the embodiments.

### Energy Storage Unit (ESU)

The ESU is a device that can store and deliver charge. It may comprise one or more power packs, which may comprise supercapacitors. The energy storage module may also comprise batteries, hybrid systems, fuel cells, etc. Capacitance provided in the components of the ESU may be in the form of electrostatic capacitance, pseudocapacitance, electrolytic capacitance, electronic double-layer capacitance, and electrochemical capacitance, and a combination thereof, such as both electrostatic double-layer capacitance and electrochemical pseudocapacitance, as may occur in supercapacitors. The ESU may be associated with or comprise control hardware and software with suitable sensors, as needed, for an energy control system (ECS) to manage any of the following: temperature control, discharging of the ESU whether collectively or of any of its components, charging of the ESU whether collectively or of any of its components, maintenance, interaction with batteries, battery emulation, communication with other devices, including devices that are directly connected, adjacent, or remotely such as by wireless communication, etc. In some aspects, the ESU may be portable and provided in a casing containing at least some components of the energy control system (ECS) and features such as communication systems, a display interface, etc.

The term supercapacitor as used herein can also refer to an ultracapacitor, which is an electrical component capable of holding hundreds of times more electrical charge quantity than a standard capacitor. This characteristic makes ultracapacitors useful in devices that require relatively little current and low voltage. In some situations, an ultracapacitor can take the place of a rechargeable low-voltage electrochemical battery. In some examples, the terms supercapacitor or ultracapacitor as used herein can also refer to other types of capacitors.

### Energy Control System (ECS)

The energy control system (ECS) combines hardware and software that manages various aspects of the ESU, including its energy to the device. The ECS regulates the energy storage unit (ESU) to control discharging, charging, and other features as desired, such as temperature, safety, efficiency, etc. The ESU may be adapted to give the ECS individual control over each power pack or optionally over each supercapacitor or grouped supercapacitor unit to tap the available power of individual supercapacitors efficiently and to properly charge individual supercapacitors rather than merely providing a single level of charge for the ESU as a whole that may be too little or too much for individual supercapacitors or their power packs.

The ECS may comprise or be operatively associated with a processor, a memory comprising code for the controller, a database, and communication tools such as a bus or wireless capabilities for interacting with an interface or other elements or otherwise providing information, information requests, or commands. The ECS may interact with individual power packs or supercapacitors through a crosspoint switch or other matrix systems. Further, the ECS may obtain information from individual power packs or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack or supercapacitor.

The ECS may comprise one or more modules that the processor can execute or govern according to code stored in a memory such as a chip, a hard drive, a cloud-based source, or another computer-readable medium.

The ECS may therefore manage any or all of the following: temperature control, discharging of the ESU whether collectively or of any of its components, charging of the ESU whether collectively or of any of its components, maintenance, interaction with batteries, or battery emulation, and communication with other devices, including devices that are directly connected, adjacent, or remotely such as by wireless communication.

The ECS may comprise one or more energy source modules that govern specific energy storage devices, such as a supercapacitor module for governing supercapacitors and a lithium module for governing lithium batteries. A lead-acid module for governing lead-acid batteries and a hybrid module for governing the combined cooperative use of a supercapacitor and a battery. Each of the energy storage modules may comprise software encoding algorithms for control such as for discharge or charging or managing individual energy sources, and may comprise or be operationally associated with hardware for redistributing charge among the energy sources to improve the efficiency of the ESU, for monitoring charge via charge measurement systems such as circuits for determining the charge state of the respective energy sources, etc., and may comprise or be operationally associated with devices for receiving and sending information to and from the ECS or its other modules, etc. The energy source modules may also cooperate with a charging module responsible for guiding the charging of the overall ESU to ensure a properly balanced charge and a discharge module that guides the efficient discharging of the ESU during use which may also seek to provide proper balance in the discharging of the energy sources.

The ECS may further comprise a dynamic module for managing changing requirements in power supplied. In some aspects, the dynamic module comprises anticipatory algorithms that seek to predict upcoming changes in power demand and adjust the state of the ECS to be ready to handle the change more effectively. For example, in one case, the ECS may communicate with a GPS and terrain map for the route being taken by the electric vehicle and recognize that a steep hill will soon be encountered. The ECS may anticipate the need to increase torque and thus the delivered electrical power from the ESU and thus activate additional power packs if only some are in use or otherwise increase the draw from the power packs to handle the change in slope efficiently to achieve desired objectives such as maintaining speed, reducing the need to shift gears on a hill, or reducing the risk of stalling or other problems.

The ECS may also comprise a communication module and an associated configuration system to properly configure the ECS to communicate with the interface or other aspects of the vehicle and communicate with central systems or other vehicles when desired. In such cases, a fleet of vehicles may be effectively monitored and managed to improve energy efficiency and track the performance of vehicles and their ESUs, thereby providing information that may assist with maintenance protocols. Such communication may occur wirelessly or through the cloud via a network interface, share information with various central databases, or access information from databases to assist with the vehicle’s operation and the optimization of the ESU, for which historical data may be available in a database.

Databases of use with the ECS include databases on the charge and discharge behavior of the energy sources in the ESU to optimize both charging and discharging in use based on known characteristics, databases of topographical and other information for a route to be taken by the electric vehicle or an operation to be performed by another device employing the ESU, wherein the database provides guidance on what power demands are to be expected in advance to support anticipatory power management wherein the status of energy sources. The available charge is prepared in time to deliver the needed power proactively. Charging databases may also help describe the characteristics of an external power source used to charge the ESU. Knowledge of the external charge characteristics can prepare for impedance matching or other measures needed to handle a new input source to charge the ESU. With that data, the external power can be received with reduced losses and reduced risk of damaging elements in the ESU by overcharge, an excessive ripple in the current, etc.

Beyond relying on static information in databases, in some aspects, the controller is adapted to perform machine learning and to learn from situations faced constantly. In related aspects, the processor and the associated software form a “smart” controller based on machine learning or artificial intelligence adapted to handle a wide range of input and a wide range of operational demands.

### ESU Hardware

### Charging and Discharging Hardware

The charging and discharging hardware comprises the wiring, switches, charge detection circuits, current detection circuits, and other devices for proper control of charge applied to the power packs or the batteries or other energy storage units and temperature-control devices such as active cooling equipment and other safety devices. Active cooling devices (not shown) may include fans, circulating heat transfer fluids that pass through tubing or, in some cases, surround or immerse the power packs, thermoelectric cooling such as Peltier effect coolers, etc.

To charge and discharge an individual unit among the power packs to optimize the overall efficiency of the ESU, methods are needed to select one or more of many units from what may be a three-dimensional or two-dimensional array of connectors to the individual units. Any suitable methods and devices may be used for such operations, including crosspoint switches or other matrix switching tools. Crosspoint switches and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. SPST (Single-Pole Single-Throw) relays, for example, may be used. By applying a charge to individual supercapacitors within power packs or to individual power packs within the ESU, a charge can be applied directly to where it is needed, and a supercapacitor or power pack can be charged to an optimum level independently of other power packs or supercapacitors.

### Configuration Hardware

The configuration hardware comprises the switches, wiring, and other devices to transform the electrical configuration of the power packs between series and parallel configurations, such as that a matrix of power packs may be configured to be in series, in parallel, or some combination thereof. For example, a 12 x 6 array of power packs may have four groups in series, with each group having 3 x 6 power packs in parallel. A command can modify the configuration from the configuration module, which then causes the configuration hardware to make the change at an appropriate time (e.g., when the device is not in use).

### Sensors

The sensors may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs or batteries or other energy storage units or other characteristics of the ESU or the device as described more fully hereafter. The sensors may comprise sensors physically contained in or on the ESU or sensors mounted elsewhere, such as engine gauges in electronic communication with the ECS or its associated ESC.

### Batteries and Other Energy Sources

The ESU may be capable of charging or supplementing the power provided from the batteries or other energy storage units, including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox flow batteries, supercapacitor batteries, and combinations or hybrids thereof.

### Power Input/Output Interface

The ESU also comprises or is associated with a power input/output interface 152 that can receive charge from a device (or a plurality of devices in some cases) such as the grid or regenerative power sources in an electric vehicle (not shown) and can deliver charge to a device such as an electric vehicle (not shown). The power input/output interface may comprise one or more inverters, charge converters, or other circuits and devices to convert the current to the proper type (e.g., AC or DC) and voltage or amperage for either supplying power to or receiving power from the device it is connected to. Bidirectional DC-DC converters may also be applied.

The power input/output interface may be adapted to receive power from various power sources, such as via two-phase or three-phase power, DC power, etc. It may receive or provide power by wires, inductively, or other proper means. Converters, transformers, rectifiers, and the like may be employed as needed. The power received may be relatively steady from the grid, or other sources at voltages such as 110 V, 120 V, 220 V, 240 V, etc., or from highly variable sources such as solar or wind power amperage or voltage vary. DC sources may be, by way of example, from 1V to 0V or higher, such as from 4 V to 200 V, 5 V to 120 V, 6 V to V, 2 V to 50 V, 3 V to 24 V, or nominal voltages of about 4, 6, 12, 18, 24, 30, or 48 V. Similar ranges may apply to AC sources, but also including from 60 V to 300 V, from 90 V to 250 V, from V to 240 V, etc., operating at any proper frequency such as 50 Hz, 60 Hz, Hz, etc.

Power received or delivered may be modulated, converted, smoothed, rectified, or transformed in any useful way to meet better the application’s needs and the requirements of the device and the ESU. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient power transfer.

The power input/out interface may have a plurality of receptacles of receiving power and a plurality of outlets for providing power to one or more devices. Conventional AC outlets may include any known outlet standard in North America, various parts of Europe, China, Hong Kong, etc.

### Energy Control System (ECS)

The energy storage unit (ESU) is governed or controlled by a novel energy control system (ECS) adapted to optimize at least one of charging, discharging, temperature management, safety, security, maintenance, and anticipatory power delivery. The ECS may communicate with a user interface such as a display interface to assist in control or monitoring of the ESU and also may comprise a processor and a memory. The ECS may interact with the ESU’s hardware, such as the charging/discharging hardware and a temperature control system that provides data to the ECS and responds to directions from the ECS to manage the ESU.

The energy control system (ECS) may comprise a processor, a memory, one or more energy source modules, a charge/discharge module, a communication module, a configuration module, a dynamic module, an identifier module, a security module, a safety module, a maintenance module, and a performance module.

### ECS Components and Modules

### Processor

The processor may comprise one or more microchips or other systems for executing electronic instructions and can provide instructions to regulate the charging and discharging hardware and, when applicable, the configuration hardware or other aspects of the ESU and other aspects of the ECS and its interactions with the device, the cloud, etc. In some cases, a plurality of processors may collaborate, including processors installed with the ESU and processors installed in a vehicle or other device.

### Memory

The memory may comprise coding to operate one or more of the ECS and their interactions with other components. It may also comprise information such as databases on any aspect of the operation of the ECS, though additional databases are also available via the cloud. Such databases can include a charging database that describes the charging and discharging characteristics of a plurality or all energy sources (the power packs and the batteries or other energy storage units ) to guide charging and discharging operations. Such data may also be included with energy-source-specific data provided by or accessed by the energy source modules.

The memory may be in one or more locations or components such as a memory chip, a hard drive, a cloud-based source, or another computer-readable medium, and maybe in any application form such as flash memory, EPROM, EEPROM, PROM, MROM, etc., or combinations thereof and consolidated (centralized) or distributed forms. The memory may, in whole or part, be a read-only memory (ROM) or random-access memory (RAM), including static RAM (SRAM), dynamic RAM (DRAM), synchronous dynamic RAM (SDRAM), and magneto-resistive RAM (MRAM), etc.

### Cloud Resources

The ECS may communicate with other entities via the cloud or other means. Such communication may involve information received from and provided to one or more databases and a message center. The message center can provide alerts to an administrator responsible for the ESU and the electric vehicle or another device. For example, an entity may own a fleet of electric vehicles using ESUs and may wish to receive notifications regarding usage, performance, maintenance issues, and so forth. The message center may also authenticate the ESU or verify its authorization for use in the electric vehicle or other devices (not shown) via interaction with the security module.

### Energy Source Modules

The energy source modules may comprise specific modules designed to operate a specific energy source, such as a supercapacitor module, a lithium battery module, a lead-acid battery module, or other modules. Such modules may be associated with a database of performance characteristics (e.g., charge and discharge curves, safety restrictions regarding overcharge, temperature, etc.) that may provide information for use by the safety module and the charge/discharge module, which is used to optimize how each unit within the power packs or batteries or other energy storage units is used both in terms of charging and delivering charge. The charge/discharge module seeks to provide useful work from as much of the charge as possible in the individual power packs while ensuring that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

### Charge/Discharge Module

The charge/discharge module is used to optimize how each unit within the power packs, batteries, or other energy storage units is used to charge and deliver charge. The charge/discharge module seeks to provide useful work from as much of the charge as possible in the individual power packs while ensuring during charging that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

The charge/discharge module may be configured to charge or discharge each of the plurality of power packs up to a threshold limit. The charge/discharge module may be coupled to the performance, energy storage, and identifier modules. It may communicate with the charging/discharging hardware of the ESU. For example, the threshold limit may be more than 90 percent attribute(s) of each of the plurality of power packs in one aspect.

### Dynamic Module

The dynamic module assists in coping with changes in operation, including acceleration, deceleration, stops, changes in slops (uphill or downhill), changes in traction or properties of the road or ground that affect traction and performance, etc., by optimizing the delivery of power or the charging that is taking place for individual power packs or batteries or other energy storage units. In addition to guiding the degree of power provided by or to individual power packs based on the current use of the device and the individual state of the power packs, in some aspects, the dynamic module provides anticipatory management of the ESU by proactively adjusting the charging or discharging states of the power packs such that added power is available as the need arises or slightly in advance (depending on time constants for the ESU and its components, anticipatory changes in status may only be needed for a few seconds (e.g., 5 seconds or less or 2 seconds or less) or perhaps only for 1 second or less such as for 0.5 seconds or less. Still, more extended preparatory changes may be needed in other cases, such as from 3 seconds to 10 seconds, to ensure that adequate power is available when needed but that power is not wasted by changing the power delivery state prematurely. This anticipatory control can involve increasing the current or voltage being delivered. Still, it can also involve increasing the cooling provided by the cooling hardware of the charging and discharging hardware in cooperation with the safety module and when suitable with the charge/discharge module.

The dynamic module may be communicatively coupled to the charge/discharge module. The dynamic module may be configured to determine the charging and discharging status of the plurality of power packs and batteries or other energy storage units in real-time. For example, in one aspect, the dynamic module may help govern bidirectional charge/discharge in real-time. The electric charge may flow from the ESU into the plurality of power packs and batteries or other energy storage units or vice versa.

### Configuration Module

The ECS may comprise a configuration module configured to determine any change in the configuration of charged power packs from the charging module. For example, in one aspect, the configuration module may be provided to charge the configuration of the power packs, such as from series to parallel or vice versa. This may occur via communication with the charging/discharging hardware of the ESU.

### Identifier Module

The identifier module, described in more detail hereafter, identifies the charging or discharging requirement for each power pack to assist in best meeting the power supply needs of the device. This process may require access to the database information about the individual power packs from the energy source modules (e.g., a supercapacitor module) and information about the current state of the individual power packs provided by the sensors and charge and current detections circuits associated with the charging and discharging hardware, cooperating with the charge/discharge module and, as needed, with the dynamic module and the safety module.

### Safety Module

The sensors may communicate with the safety module to determine if the power packs and individual components show excessive local or system temperature signs that might harm the components. In such cases, the safety module interacts with the processor and other features (e.g., data stored in the databases of the cloud or memory pertaining to safe temperature characteristics for the ESU ) to cause a change in operation such as decreasing the charging or discharging underway with the portions of the power packs or other units facing excessive temperature. The safety module may also regulate cooling systems that are part of the charging and discharging hardware to proactively increase the cooling of the power packs, batteries, or other energy storage units. Increasing the load on them does not lead to harmful temperature increases.

Thus, the safety module may also interact with the dynamic module in responding to forecasts of system demands in the near future for anticipatory control of the ESU for optimized power delivery. In the interaction with the dynamic module, the safety module may determine that an upcoming episode of high system demand such as imminent climbing of a hill may impose excessive demands on a power pack already operating at elevated temperature, and thus make a proactive recommendation to increase cooling on the at-risk power packs. Other sensors such as strain gauges, pressure gauges, chemical sensors, etc., may be provided to determine if any of the energy storage units in batteries or other energy storage units or the power packs are facing pressure buildup from outgassing, decomposition, corrosion, electrical shorts, unwanted chemical reactions such as an incipient runaway reaction, or other system difficulties. In such cases, the safety module may initiate precautionary or emergency procedures such as a shutdown, electrical isolation of the affected components, warnings to a system administrator via the communication module to the message center, a request for maintenance to the maintenance module.

### Maintenance Module

The maintenance module determines when the ESU requires maintenance, either per a predetermined scheduled or when needed due to apparent problems in performance, as may be flagged by the performance module, or in issues about safety as determined by the safety module based on data from sensors or the charging/discharging hardware, and in light of information from the energy sources modules. The maintenance module may cooperate with the communication module to provide relevant information to the display interface and the message center. An administrator or owner may initiate maintenance action in response to the message provided. The maintenance module may also initiate mitigating actions to be taken, such as cooperating with the charge/discharge module to decrease the demand on one or more of the power packs in need of maintenance and may also cooperate with the configuration module to reconfigure the power packs to reduce the demand in components that may be malfunctioning of near to malfunctioning to reduce harm and risk.

### Performance Module

The performance module continually monitors the results obtained with individual power packs and the batteries or other energy storage units and stores information as needed in memory and the cloud databases or via messages to the message center. The monitoring is done by using the sensors and the charging/discharging hardware, etc. The tracking of performance attributes of the respective energy sources can guide knowledge about the system’s health, the capabilities of the components, etc., which can guide decisions about charging and discharging in cooperation with the charge/discharge module. The performance module compares actual performance, such as power density, charge density, time to charge, thermal behavior, etc., to specifications and can then cooperate with the maintenance module to help determine if maintenance or replacement is needed, and alert an administrator via the communication module with a message to the message center about apparent problems in product quality.

### Security Module: Security and Anti-Counterfeiting Measures

The security module helps reduce the risk of counterfeit products or theft or misuse of legitimate products associated with the ESU, thus including one or more methods for authenticating the nature of the ESU and authorization to use it with the device in question. Methods of reducing the risk of theft or unauthorized use of an ESU or its respective power packs can include locks integrated with the casing of the ESU that mechanically secure the ESU in the electric vehicle or other devices, wherein a key, a unique fob, a biometric signal such as a fingerprint or voice recognition system, or other security-related credentials or may be required to enable removal of the ESU or even operation thereof.

In another aspect, the ESU comprises a unique identifier (not shown) that can be tracked, allowing a security system to verify that a given ESU is authorized for use with the device, such as an electric vehicle or other devices. For example, the casing of the ESU or one or more power packs therein may have a unique identifier attached, such as an RFID tag with a serial number (an active or passive tag), a holographic tag with unique characteristics equivalent to a serial number or password, nanoparticle markings that convey a unique signal, etc. One good security tool that may be adapted for the security of the ESU is a seemingly ordinary bar code or QR code with unique characteristics not visible to the human eye that cannot be readily copied, is the Unisecure™ technology offered by Systech (Princeton, NJ), a subsidiary of Markem-Image, that essentially allows ordinary QR codes and barcodes to become unique, individual codes by analysis of tiny imperfections in the printing to uniquely and robustly identify every individual product, even if it seems that the same code is printed on every one.

Yet another approach relies at least in part on the unique electronic signature of the ESU and one or more individual power packs or of one or more supercapacitor units therein. The principle will be described relative to an individual power pack but may be adapted to an individual supercapacitor or collectively to the ESU as a whole. When a power pack comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack may then be tested using any suitable tool capable of identifying a signature specific to the individual power pack.

### Communication Module

The communication module can govern communications between the ECS and the outside world, including communications through the cloud, such as making queries and receiving data from various external databases or sending messages to a message center where they may be processed and archived by an administrator, a device owner, the device user, the ESU owner, or automated systems. In some aspects, the communication module may also oversee communication between modules or between the ESU and the ECS and work in cooperation with various modules to direct information to and from the display interface. Communications within a vehicle or between the ECS or ESU and the device may involve a DC bus or other means such as separate wiring. Any suitable protocol may be used, including UART, LIN (or DC-LIN), CAN, SPI, I2C (including Intel’s SMBus), and DMX (e.g., DMX512). In general, communications from the ECS or ESU with a device may be over a DC bus or, if needed, over an AC/DC bus, or by separately wired pathways if desired, or wireless.

Communication to the cloud may occur via the communication module and involve wired or wireless connections. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

### Electrostatic Module

Assessment of charge in an energy storage unit can be conducted based on measurements made with the charging/discharging hardware in communication with specific modules of the ECS. In general, an electrostatic module can manage the measurement of charge and processing of the data.

The electrostatic module may be configured to identify the power pack type and the attribute(s) of each power pack connected to the modular multi-type power pack energy storage unit. Further, the electrostatic module may be configured to retrieve information related to the type of power packs from the charging database. The electrostatic module may determine the attribute(s) of each power pack to be charged. It may be configured to determine the attribute(s) of each power pack when connected to the modular multi-type power pack ESU.

The electrostatic module may be configured to determine if each power pack charged below the threshold limit. For example, in one aspect, the electrostatic module may check whether each of the plurality of power packs may have a attribute(s) below the threshold limit. The electrostatic module may also be configured to send data related to power packs to the ECS.

### Various Databases

The ECS may access various databases via an interface to the cloud and store retrieved information in the memory to guide the various modules.

Further, the memory may comprise a charging database or information from such a database obtained from the databases or the cloud. In one aspect, the charging database may be configured to store information related to various power packs used while charging and discharging from the ESU. In one aspect, the charging database may be configured to store information related to the power cycle of each of the plurality of power packs, the maximum and minimum charge for different types of power packs, and the state of charge (SoC) profile of each of the plurality of power packs.

The charging database may be configured to store information related to managing the plurality of power packs, such as the type of power pack to be charged, safety specifications, recent performance data, bidirectional charging requirements, or history of each of the plurality of power packs, etc. In another aspect, the stored information may also include, but is not limited to, the attribute(s) of each of the plurality of power packs, amount of charge required for one trip of the electric vehicle along the path, such as golf course, etc., charging required for a supercapacitor unit, etc. In another aspect, the charging database may provide a detailed research report for the electric vehicle’s average electric charge consumption over a path. In one aspect, the charging database may be configured to store information of the consumption of the electric charge per unit per kilometer drive of the electric vehicle from the plurality of power packs. For example, such information may indicate that a golf cart is equipped with five supercapacitor-driven power packs each at 90% charge, with each power packable to supply a specified amount of ampere-hours (Ah) of electric charge resulting in an ability to drive under normal conditions at top speed for, say, 80 kilometers. The information may also indicate that a solar cell installed on the roof of the golf cart would, under current partly clouded conditions, still provide enough additional charge over the planned period of use to extend the attribute(s) of the ESU by another 40 kilometers for one passenger.

The performance module may use the charging database to read data and store new data on the individual energy storage units such as the power packs.

### Power Pack

A power pack is a unit that can store and deliver charge within an energy storage unit and comprises one or more supercapacitors such as supercapacitors in series and parallel. It may further comprise or cooperate with temperature sensors, charge and current sensors (circuits or other devices), connectors, switches such as crosspoint switches, safety devices, and control systems such as charge and discharge control systems. In various aspects described herein, the power pack may comprise a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack may have a functional temperature range from -70° C. to +°C, such as from -50° C. to °C or from -40° C. to 80° C. The voltage provided by the power pack may be any practical value such as 3 V or more significant, such as from 3 V to 240 V, 4 V to 120 V, etc.

By way of example, a power pack may comprise one or more units, each comprising at least one supercapacitor having a nominal voltage from 2 to 12 V, such as from 3 to 6 V, including supercapacitors rated at about 3, 3.5, 4, 4.2, 4.5, and 5 V. For example, in discharge testing, a power pack was provided and tested with 14 capacitors in series and five series in parallel charged with 21,000F at 4.2 V and had 68-75 Wh. Power packs may be packaged in protective casings that can easily be removed from an ESU and replaced. They may also comprise connectors for charging and discharging. Power packs may be provided with generally rectilinear casings, or they may have cylindrical or other useful shapes.

### Supercapacitor Information

### Supercapacitors

A supercapacitor may have two electrode layers separated by an electrode separator wherein each electrode layer is electrically connected to a current collector supported upon an inert substrate layer; further comprising an electrolyte-impervious layer disposed between each electrode layer and each conducting layer to protect the conducting layer, and a liquid electrolyte disposed within the area occupied by the active electrode layers and the electrode separator. To inhibit electrolyte flow, the liquid electrolyte may be an ionic liquid electrolyte gelled by a silica gellant or other gellant.

The supercapacitor may comprise an electrode plate, an isolation film, a pole, and a shell. The electrode plate comprises a current collector, and a coating is disposed of on the current collector. The coating may comprise an active material that may include carbon nanomaterial such as graphene or carbon nanotubes, including nitrogen-doped graphene, a carbon nitride, carbon materials doped with a sulfur compound such as thiophene or poly 3-hexylthiophene, etc., or graphene on which is deposited nanoparticles of metal oxide such as manganese dioxide. The coating may further comprise a conductive polymer such as one or more polyaniline, polythiophene, and polypyrrole. Such polymers may be doped with various substances such as boron (especially in the case of polyaniline).

Electrodes in supercapacitors may have thin coatings in electrical communication with a current collector, to provide high electrode surface area for high performance, electrodes may comprise porous material with a high specific surface area such as graphene, graphene oxide, or various derivatives of graphene, carbon nanotubes or other carbon nanomaterials including activated carbon, nitrogen-doped graphene or another doped graphene, graphite, carbon fiber-cloth, carbide-derived carbon, carbon aerogel. They may comprise various metal oxides such as oxides of manganese, etc. All such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors about charge state, temperature, and other performance and safety aspects. An actuation mechanism may be integrated to prevent undesired discharge.

The voltage of an individual supercapacitor may be greater than 2 V, such as from 2.5 V to 5 V, 2.7 V to 8 V, 2.5 V to 4.5 V, etc.

Supercapacitors can be divided into units of smaller supercapacitors. In one embodiment, a “constant voltage unit” of five units can be joined together in parallel to maintain the voltage but supply five times more current. In another embodiment, a “constant current unity” can include five units joined together in series to multiply the unit voltage by five times but maintain the current. In another embodiment, supercapacitors can provide hybrid “constant voltage units” and “constant current units.” In yet another embodiment, supercapacitors units can be connected in any number of combinations to end up with a supercapacitor of optimum design. In another embodiment, each supercapacitor unit can comprise various subunits or pouches. Supercapacitor subunits can be combined using constant current subunits, constant voltage subunits, or any combination. In yet another embodiment, supercapacitor units or sub-units can comprise size or form factors. In yet another embodiment, each subunit and unit can be uniquely addressed to turn on or off the supercapacitor unit or sub-unit on or off. This is achieved with any variety of crossbar switches. A crossbar switch is an assembly of individual switches between inputs and a set of outputs. The switches are arranged in a matrix. If the crossbar switch has M inputs and N outputs, then a crossbar has a matrix with M x N cross-points or places where the connections cross. At each crosspoint is a switch; when closed, it connects one of the inputs to one of the outputs. A given crossbar is a single layer, non-blocking switch. A non-blocking switch means that other concurrent connections do not prevent connecting other inputs to other outputs. Collections of crossbars can be used to implement multiple layers and blocking switches. A crossbar switching system is also called a coordinate switching system. In this way, a crossbar switch can select any combinations of pouches or subunits and units to obtain any combination. The crossbar switches can be used for testing units or subunits and optimizing supercapacitor performance.

### Powered Devices and Electric Vehicles, Etc

Powered devices powered by the ESU can include electric vehicles and other transportation devices of all kinds, such as those for land, water, or air, whether adapted to operate without passengers or with one or more passengers. Electric vehicles may include automobiles, trucks, vans, forklifts, carts such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like, etc. The electric vehicle generally comprises one or more motors connected to the ESU and an energy control system (ECS) that controls the power delivered from the ESU and may comprise a user interface that provides information and control regarding the delivery of power from the ESU as well as information regarding performance, remaining charge, safety, maintenance, security, etc. Not all transportation devices require non-stationary motors. An elevator, for example, may have a substantially stationary motor while the cabin moves between the level of a structure. Other transport systems with mobile cabins, seats, or walkways may be driven by stationary motors driving cables, chains, gears, bands, etc.

Apart from electric vehicles, there are many other devices that the ESU may power in cooperation with the ESC. Such other devices can include generators, which in turn can power an endless list of electric devices in households and industry. ESUs of various sizes and shapes can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, personal protection tools such as tasers, lighting and heating systems, power tools, computers, phones, tablets, electric games, etc. In some versions, the powered device is the grid, and in such versions, the ESU may comprise an inverter to turn DC into AC suitable for the grid.

In some aspects, a plurality of devices such as electric vehicles may be networked together via a cloud-based network, wherein the devices share information among themselves and with a central message center such that an administrator can assist in managing the allocation of resources, oversee maintenance, evaluate the performance of vehicles and ESUs, upgrade software or firmware associated with the ESC to enhance performance for the particular needs of individual users or a collective group, adjust operational settings to better cope with anticipated changes in weather, traffic conditions, etc., or otherwise optimize performance.

### Implementation in Hybrid Vehicles

When installed in electric vehicles, the ESU may comprise both power packs and one or more lead-acid batteries or other batteries. The ESU may power both the motor and the onboard power supply system. The display interface of the associated ESC may comprise a graphical user interface such as the vehicle’s control panel (e.g., a touch panel). The display interface may also comprise audio information and verbal input from a user.

### Motors

The ESU may power any electric motor. The major classes of electric motors are: 1) DC motors, such as series, shunt, compound wound, separately excited (wherein the connection of stator and rotor is made using a different power supply for each), brushless, and PMDC (permanent magnet DC) motors, 2) AC motors such as synchronous, asynchronous, and induction motors (sometimes also called asynchronous motors), and 3) special purpose motors such as servo, stepper, linear induction, hysteresis, universal (a series-wound electric motor that can operate on AC and DC power), and reluctance motors.

### Display Interface

The display interface of the ESC may be displayed on or in the device, such as on a touch screen or other display in a vehicle or on the device, or it may be displayed by a separate device such as the user’s phone. The display interface may comprise or be part of a graphic user interface such as the vehicle’s control panel (e.g., a touch panel). The display interface may also comprise audio information and verbal input from a user. It may also be displayed on the ESU itself or a surface connected to or communicated with the ESU. In one version, the display interface may include but is not limited to a video monitoring display, a smartphone, a tablet, and the like, each capable of displaying a variety of parameters and interactive controls. Still, the display could also be as simple as one or more lights indicating charging or discharging status and optionally one or more digital or analog indicators showing remaining useful lifetime, % power remaining, voltage, etc.

Further, the display interface may be any state-of-the-art display means without departing from the scope of the disclosure. In some aspects, the display interface provides graphical information on charge status, including one or more fractions of charge remaining or consumed, remaining useful life of the ESU or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU for shipping, discharge the ESU, increase active cooling, only apply low power, etc.); planned conditions for use (e.g., outdoors, high-humidity, in the rain, underwater, indoors, etc.). Selections may be made through menus and buttons on a visual display, through audio “display” of information responsive to verbal commands, or through text commands or displays transmitted to a phone or computer, including text messages or visual display via an app or web page.

Thus, the ESU may comprise a display interface coupled to the processor to continuously display the status of charging and discharging the plurality of power packs.

### General

All patents and applications cited must be understood as being incorporated by reference to the degree they are compatible.

For all ranges given herein, it should be understood that any lower limit may be combined with any upper limit when feasible. Thus, for example, citing a temperature range of from 5° C. to °C and from 20° C. to 200° C. would also inherently include a range of from 5° C. to 200° C. and a range of 20° C. to °C.

When listing various aspects of the products, methods, or system described herein, it should be understood that any feature, element, or limitation of one aspect, example, or claim may be combined with any other feature, element, or limitation of any other aspect when feasible (i.e., not contradictory). Thus, disclosing an example of a power pack comprising a temperature sensor and then a different example of a power pack associated with an accelerometer would inherently disclose a power pack comprising or associated with an accelerometer and a temperature sensor.

Unless otherwise indicated, components such as software modules or other modules may be combined into a single module or component or divided. The function involves the cooperation of two or more components or modules. Identifying an operation or feature as a single discrete entity should be understood to include division or combination such that the effect of the identified component is still achieved.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used to practice or test embodiments, only some exemplary systems and methods are now described.

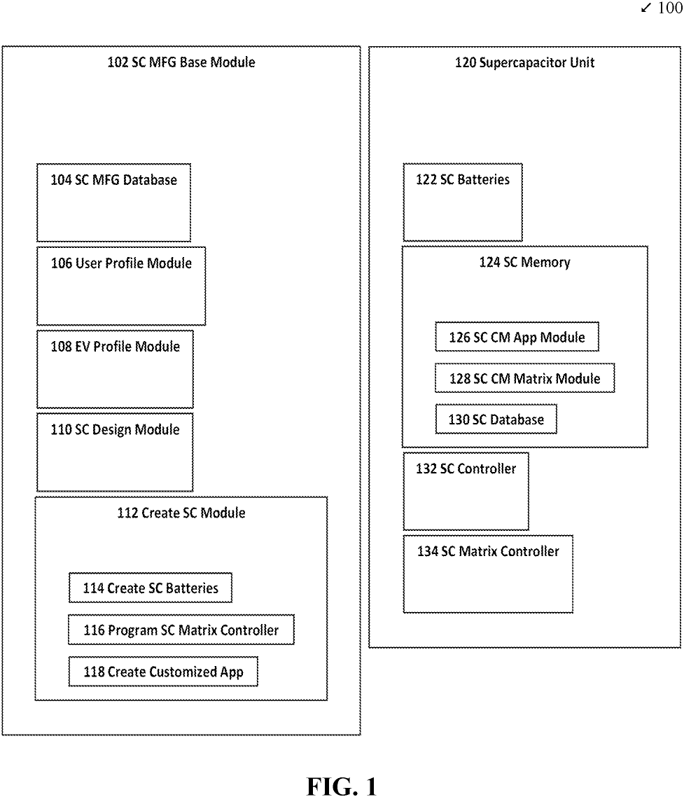

FIG. 1 is a block diagram illustrating an architecture of an energy management system 100. The energy management system 100 may perform a process for identifying User-defined Electric Vehicle Supercapacitor batteries. The process begins with a supercapacitor (SC) manufacturing (MFG) Base Module 102 may be a software program that runs on a server of a Supercapacitor Manufacturing company. SC MFG Base Module 102 may include a business model to customize Supercapacitor Unit 120 for users for a fee. SC MFG Base Module 102 may be a 3rd party software and business model that interfaces to supercapacitor battery. SC MFG Base Module 102 executes User Profile Module 106. SC MFG Base Module 102 executes EV Profile Module 108. SC MFG Base Module 102 executes SC Design Module 110. SC MFG Base Module 102 executes Create SC Module 112. SC MFG Base Module 102 ships SuperCapacitor batteries to the user. SC MFG Database 104 stores all the data for accepting user inputs, calculating Supercapacitor designs and supercapacitor design results. User Profile Module 106 inputs User Identifier information, a user driving information, User Profile information such as geolocation data, User loading data, and Other data. The EV Profile Module 108 inputs Electric Vehicle Identification data, such as supercapacitor requirements which may have various options to create extra attribute(s) or range or safety. This data could be obtained . SC Design Module 110 calculates User Attribute(s) requirements for Users.

Create SC Module 112 executes Create SC Batteries 114, Program SC Matrix Controller 116, and Customized App 118. Create SC Batteries 114 determines if the supercapacitor battery from design module 110 is in stock (including supercapacitor batteries that were increased in a attribute(s) in stock) or not. Create SC Batteries 114, then determines if the designed supercapacitor is not in stock. The Create SC Batteries 114 determines the attribute(s) delta from the closet in-stock battery that can be expanded, which is a request to build an expansion battery. Create SC Batteries 114, then determines if the supercapacitor other additions that are not in stock, such as added temperature sensors, then add these additions to the request to build an extension battery.

Program SC Matrix Controller 116 determines the final Supercapacitor design to the user. Program SC Matrix Controller 116 downloads software configuration to the supercapacitor SC Matrix controller. Create Customized App 118 determines the customized App design to be shipped to the user. Supercapacitor Unit 120 is explicitly designed for users and their Electric Vehicle. SC Batteries 122 are the supercapacitor batteries units and subunits. SC Memory 124 is the memory that is added to the supercapacitor unit 120 at SC memory 124.

SC CM App Module 128 is the customized app software available to the user as a companion to the supercapacitor unit 120. The SC CM App module allows for interaction with the customized App that can be downloaded by the user. SC CM Matrix Module 128 represents the software that controls the SC controller 132. SC Database 130 is the database that the supercapacitor unit 120 has onboard that stores all data downloaded from the SC MFG database 104 for the particular user. SC Controller 132 controls the flow of information from the supercapacitor unit 120 and the Electric Vehicle, not shown at SC controller 132. SC Matrix Controller 134 controls the crossbar switch on the supercapacitor unit 120 and is controlled via the SC CM Matrix Module 128, at SC Matrix Controller 134.

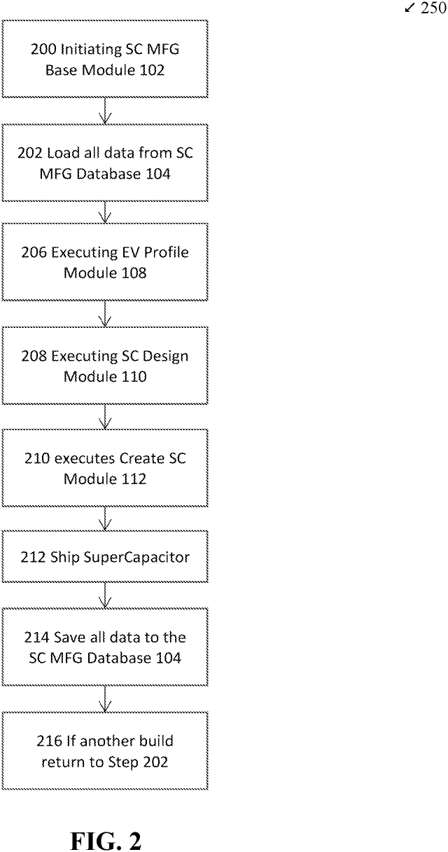

Functioning of the “SC MFG Base Module” will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 2 is a flow diagram illustrating a process 250 performed using an SC MFG base module 102. The process 250 begins with SC MFG Base Module 102 being initiated. SC MFG Base Module 102 may be a software program that runs on a server of a Supercapacitor Manufacturing company. SC MFG Base Module 102 may include a business model to customize Supercapacitor Unit 120 for users for a fee. SC MFG Base Module 102 maybe a 3rd party software and business model that interfaces to supercapacitor battery manufacturers at operation 200. SC MFG Base Module 102 loads all data from SC MFG Database 104. SC MFG Database 104 stores all historical related to Electric Vehicles in terms of Electric Vehicle make, year and model numbers, and the basic super capacitor units available for the Electric Vehicle. There could be a range of options available for supercapacitor batteries for any electric vehicle that could (1) increase their range, (2) increase time between charges, (3) have extended lifetime, (4) improve energy optimization, (5) provide more load capability, etc. The SC MFG Database 104 would also store various user profile information, Electric Vehicle profiles, SC Design Module data, and any programs needed to design or create supercapacitors. SC MFG Database 104 would also store data related to customized apps at operation 202. SC MFG Base Module 102 executes User Profile Module 106 at operation 204. SC MFG Base Module 102 executes EV Profile Module 108 at operation 206. SC MFG Base Module 102 executes SC Design Module 110 at operation 208. SC MFG Base Module 102 executes Create SC Module 112 at operation 210. SC MFG Base Module 102 ships SuperCapacitor batteries to the user at operation 212. SC MFG Base Module 102 saves all SC MFG Database 104 at operation 214. SC MFG Base Module 102 determines if another build is requested and control returns to operation 202., at operation 216.

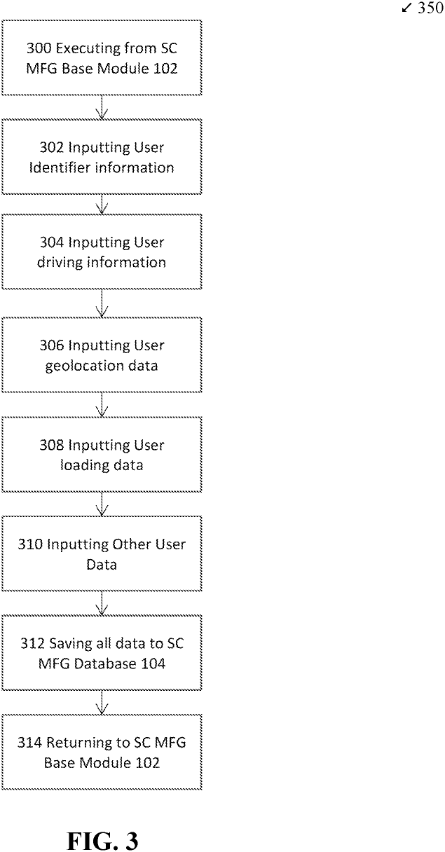

Functioning of the “User Profile Module” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 3 is a flow diagram illustrating a process 350 performed using a user profile module 106. The process 350 begins with User Profile Module 106 executed from SC MFG Base Module 102, at operation 300. User Profile Module 106 inputs User Identifier information. User Identification would identify the user, such as name, financial data, address, etc. This data is stored in the SC MFG Database 104, at operation 302. User Profile Module, 106 inputs User, driving information. User driver information is obtained by answering survey questions to obtain user driver habits, such as average speed willing to drive, acceleration desired, how much braking may be required, etc. User driving data can determine supercapacitor energy for electric vehicle range, etc. This data is stored in the SC MFG Database 104, at operation 304. User Profile Module 106 inputs User geolocation data. Geolocation data represents map coordinates of where the Electric Vehicle is driven. The geolocation data will allow for calculation of terrain and weather and amount of stop and go traffic which assists in determining supercapacitor design, such as temperature gradient and cooling design, attribute(s), etc. This data is stored in the SC MFG Database 104, at operation 306. User Profile Module 106 inputs User loading data. Loading data may include average passenger weight, average belongings weight, etc. Loading data can be used to determine supercapacitor battery attribute(s) needs. This data is stored in the SC MFG Database 104, at operation 308. User Profile Module 106 inputs Other User Data. Other data may include any other data that can impact supercapacitor design, such as but not limited to. These maintenance requirements could produce backup supercapacitor batteries or battery secondary support technology, like solar cells on an Electric vehicle that allows supercapacitors to be recharged constantly, allowing supercapacitors attribute(s) needs to be reduced, etc. Other data could also represent user external power needs such as remote power for music or cooking etc., that would connect to the Electric Vehicle. This data is stored in the SC MFG Database 104, at operation 310. User Profile Module 106 saves all data to SC MFG Database 104. at operation 312. User Profile Module 106 returns to SC MFG Base Module 102. This data is stored in the SC MFG Database 104, at operation 314.

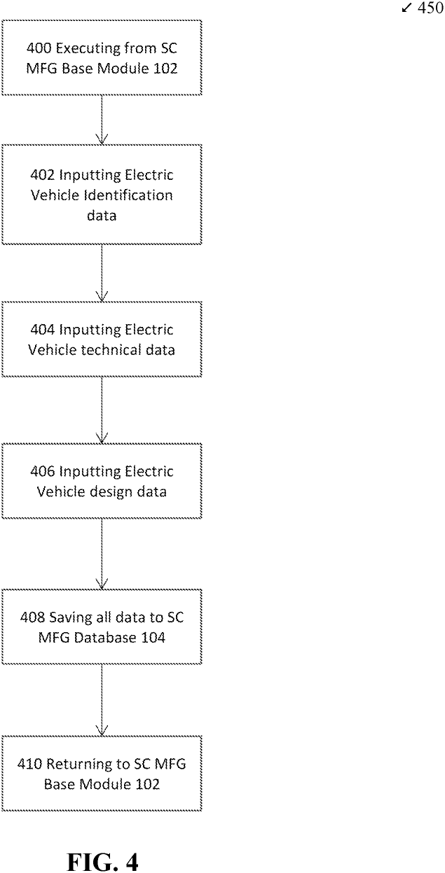

Functioning of the “EV Profile Module” will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 4 is a flow diagram illustrating a process 450 performed using an EV profile module 108. The process 450 begins with EV Profile Module 108, executed from SC MFG Base Module 102. All data is inputted from SC MFG Database 104, at operation 400. EV Profile Module 108 inputs Electric Vehicle Identification data. Each electric vehicle has specifications for its designs, some related to supercapacitors. In some embodiments, the supercapacitor requirements can use various options to create extra attribute(s) or range, or safety, and this data could be obtained. For example, Model 515 Golf Cart with average supercapacitors has an average range of 10 miles without a charge after a full charge for an average load of two users and golf bags. For example, Model 622 Golf Cart has an average range of 15 miles without a charge after a full charge for an average load of two users and golf bags. The data is stored in the SC MFG Database 104, at operation 402. EV Profile Module 108 inputs Electric Vehicle technical data. Each electric vehicle has technical specifications for its designs for supercapacitors. In some embodiments, the supercapacitor technical requirements can use various options to create extra attribute(s) or range, or safety, and this technical data could be obtained. For example, Model 515 Golf Cart with average supercapacitors has an average range of 10 miles without a charge if low windy areas after a full charge for an average load of two users and golf bags. For example, Model 622 Golf Cart with average supercapacitor unis has an average range of 9 miles with high wind speeds of 10MPH over one charge for an average load of two users and golf bags. The data is stored in the SC MFG Database 104, at operation 404. EV Profile Module 108 inputs Electric Vehicle design data. Each electric vehicle has design specifications for its supercapacitors. In some embodiments, the supercapacitor design requirements can use various options that can create extra attribute(s) or range, or safety. For example, this design data could be obtained-Model 515 Golf Cart with supercapacitor unit with built-in temperature safety temperature sensors. For example, the Model 622 Golf Cart has a 12V DV port to charge other devices. The data is stored in the SC MFG Database 104, at operation 406. EV Profile Module 108 saves all data to SC MFG Database 104, at operation 408. EV Profile Module 108 returns to SC MFG Base Module 102, at operation 410.

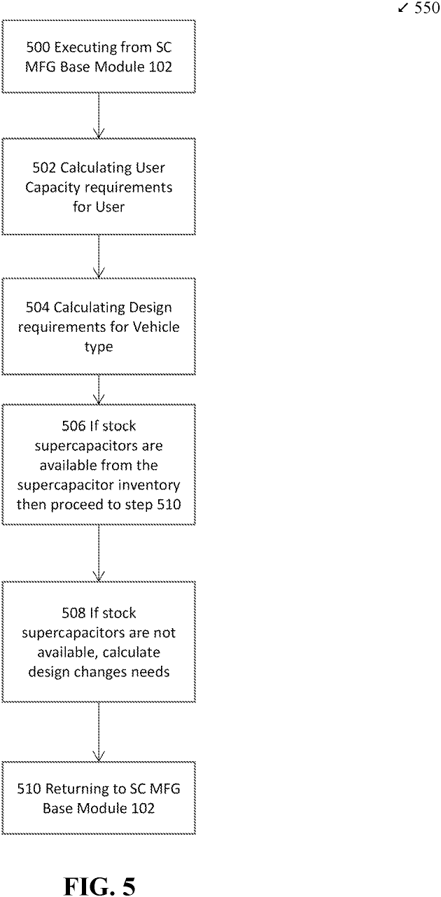

Functioning of the “SC Design Module” will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 5 is a flow diagram illustrating a process 550 performed using an SC design module 110. The process 550 begins with SC Design Module 110 executed from SC MFG Base Module 102, at operation 500. SC Design Module 110 calculates User Attribute(s) requirements for Users.

User Profile Table 1

| | | | Calculated Capacity Delta | Calculated Capacity Delta |
|---|---|---|---|---|
| user | 1555 | 2215 | 1555 | 2215 |
| Average Speed | 5 MPH | 10 MPH | 0 | 10% |
| Acceleration | normal | Fast | 0 | 5% |
| Average trip | 6 Miles | 4 Miles | 10% | 0 |
| braking | little | Quick Stops | 0 | 2% |
| geolocation | Florida | Vermont | 10% | 5% |
| Temperature | Hot | average cold | N/A | N/A |
| loading - people | 1 | 2 to 3 | 0 | 5% |
| Loading - gear | golf bags only | 2 Golf Bags and cooler | 0 | 2% |
| Other | have solar cells on vehicle | use external charged boombox | -30% | 2% |

As shown in User Profile Table 1, the variations are obtained for several users of golf carts and their range and attribute(s) needs for supercapacitors unit 120. When creating SC Battery choices in Create SC Batteries 114, Calculated Attribute(s) Deltas to the average super attribute(s) designs can modify the average supercapacitor units 120 in the Calculated Attribute(s) Delta columns. For example, user 1555 would some up to a minus ten percent offset due to solar cells so that model’s average supercapacitor unit 120 can be used. On the other hand, user 2215 would need a thirty-one percent change (adding all the percentage changes in the calculated Attribute(s) Delta column). This means the supercapacitor battery attribute(s) needs to be increased thirty-one percent higher. This means the user attribute(s) needs to be seventeen percent higher. It should be noted that the attribute(s) percent changes can be obtained from a lookup of database SC MFG Database 104 or can be calculated by an algorithm at operation 502. SC Design Module 110 calculates User Design requirements for Users.

EV Profile Table 2

| | | | Design Delta | Design Delta |
|---|---|---|---|---|
| EV Model | 515 | 622 | 515 | 622 |
| Average Range | 10 miles | 9 mile | none | add 10% more capacity |
| Wind delta | low wind | high wind speeds 10 MPH | none | add 5% more capacity |
| Temperature Sensor | Yes | No | add SC Control software | none |
| Expandable DC | No | Yes | none | add 2% capacity |

As shown in EV Profile Table 2, the variations are obtained for several golf cart models 515 and 622. When creating SC Battery choices in Create SC Batteries 114, Design Deltas to the average model design for supercapacitor designs can be calculated as shown. For example, model 515 can use the average supercapacitor attribute(s) so that model’s average supercapacitor unit 120. However, Model 515, when designing the supercapacitor unit 120, temperature sensor control software would need to be added. On the other hand, model 622 would need a seventeen percent change (adding all the percentage changes in the design Delta column). This means the user attribute(s) needs to be seventeen percent higher.

It should be noted that the attribute(s) percent changes can be obtained from a lookup of database SC MFG Database 104 or can be calculated by an algorithm. It should be noted that after the user attribute(s) requirements and design requirements are calculated, they are added together to determine the final supercapacitor changes related to the average supercapacitor unit installed. All the data is stored in SC MFG Database 104, at operation 504. If stock supercapacitors are available from the supercapacitor inventory, proceed to operation 510. For example, if the final supercapacitor from operations 502 and 504 is calculated to be the average attribute(s) plus 50% with a temperature sensor, and that supercapacitor is in stock, this stock item is in stock identified to be sold to the user. The data is then stored in the SC MFG Database 104, at operation 506. SC Design Module 110 calculates design changes needs if stock supercapacitors are unavailable. For example, suppose the final supercapacitor from operations 502 and 504 is calculated to be the average attribute(s) plus 31% with a temperature sensor, and that supercapacitor is not in stock. In that case, a calculation is done to increase the supercapacitor to high percentages until a supercapacitor in stock is found. If other factors like temperature sensors are not available, the system notes this information in the SC MFG Database 104, at operation 508. SC Design Module 110 calculates returns to SC MFG Base Module 102, at operation 510.

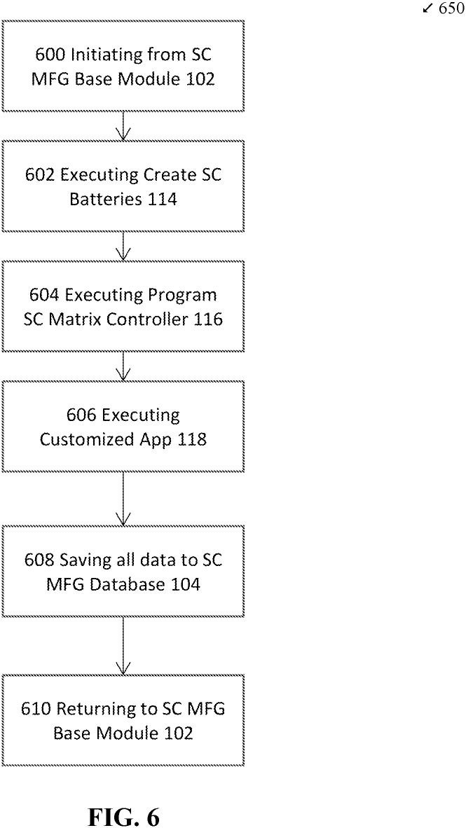

Functioning of the “Create SC Module” will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 6 is a flow diagram illustrating a process 650 performed using a create SC module 112. The process 650 begins with Create SC Module 112 initiates from SC MFG Base Module 102, at operation 600. Create SC Module 112 executing Create SC Batteries 114, at operation 602. Create SC Module 112 executes Program SC Matrix Controller 116, at operation 604. Create SC Module 112 executes Customized App 118, at operation 606. Create SC Module 112 saves all data to SC MFG Database 104, at operation 608. Create SC Module 112 returns to SC MFG Base Module 102, at operation 610.

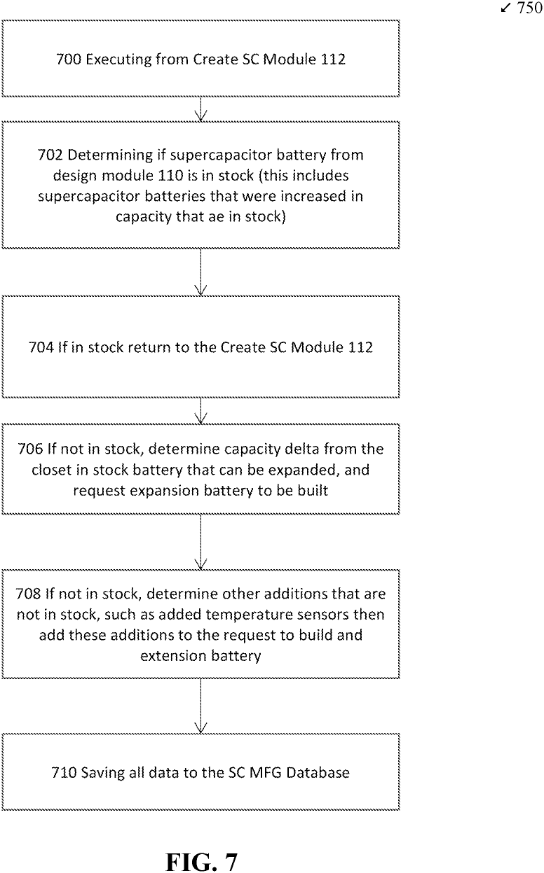

Functioning of the “Create SC Batteries” will now be explained with reference to FIG. 7. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 7 is a flow diagram illustrating a process 750 performed using a create SC module 112. The process 750 begins with Create SC Batteries 114 executes from Create SC Module 112, at operation 700. Create SC Batteries 114 determines if the supercapacitor battery from design module 110 is in stock (including supercapacitor batteries that were increased in a attribute(s) in stock) at operation 702. Create SC Batteries 114, then determines If the supercapacitor designed is in stock and returns to the Create SC Module 112 at operation 704. Create SC Batteries 114, then determines if the designed supercapacitor is not in stock. The Create SC Batteries 114 determines the attribute(s) delta from the closet in-stock battery that can be expanded, which is a request to build an expansion battery. For example, suppose the attribute(s) of the delta is 65%, and the closest supercapacitor is an average battery attribute(s) plus 50%. In that case, it is expandable (an expansion can be easily connected), them a 15% supercapacitor expansion battery is requested. Not shown is that the closest supercapacitor is an average battery attribute(s), plus 50% is locked from inventory and identified to be matched together when the 15% supercapacitor expansion arrives, at operation 706. Create SC Batteries 114, then determines if the supercapacitor other additions that are not in stock, such as added temperature sensors, then add these additions to the request to build an extension battery, at operation 708. Create SC Batteries 114, then saves all data to the SC MFG Database at operation 710.

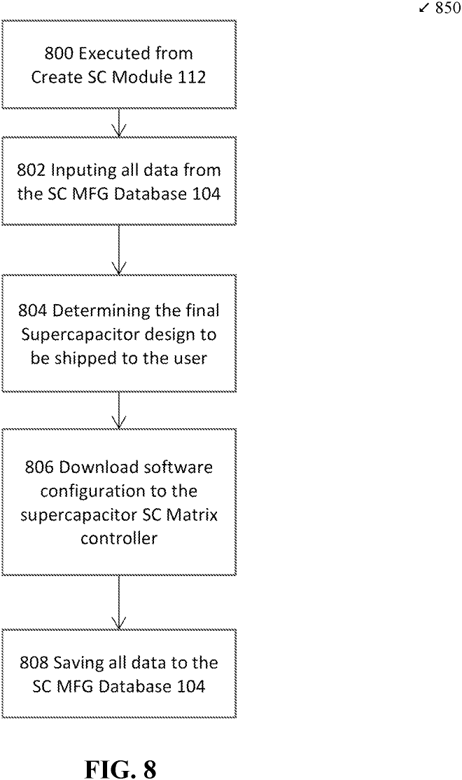

Functioning of the “Program SC Matrix Controller” will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 8 is a flow diagram illustrating a process 850 performed using a program SC matrix controller 116. The process 850 begins with Program SC Matrix Controller 116 executes from Create SC Module 112, at operation 800. Program SC Matrix Controller 116 inputs all SC MFG Database 104 data at operation 802. Program SC Matrix Controller 116 determines the final Supercapacitor design to be shipped to the user at operation 804. Program SC Matrix Controller 116 download software configuration to the supercapacitor SC Matrix controller. Each supercapacitor battery has crossbar switching hardware that can address every supercapacitor unit and subunit to have the supercapacitor unit have the correct voltages and attribute(s). Once this SC Matrix controller is programmed, the data is stored in the SC Memory 124 SC CM Matrix Module 128. This allows, in real-time operation for the supercapacitor voltages and attribute(s) to stay as close to a specification designed as possible, at operation 806. Program SC Matrix Controller 116 saves all data to the SC MFG Database 104, at operation 808.

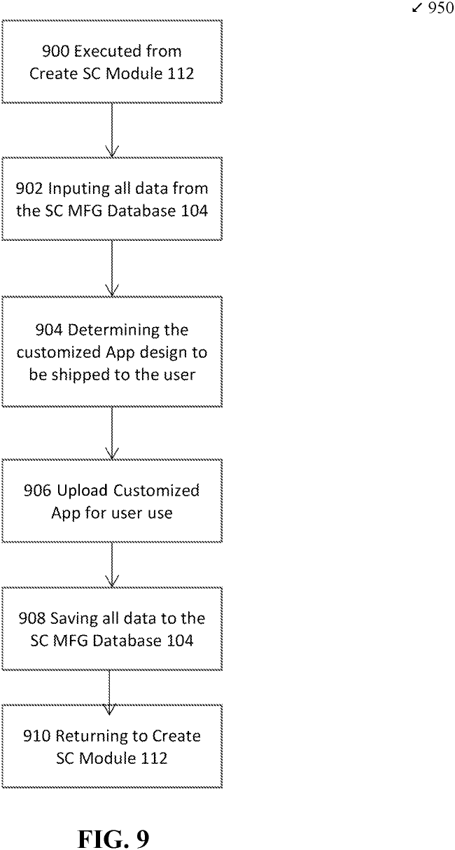

The “Create Customized App” function will now be explained concerning FIG. 9. One skilled in the art will appreciate that, for this and other processes and methods disclosed herein, the functions performed in the processes and methods may be implemented in differing order. Furthermore, the outlined steps and operations are only provided as examples. Some of the steps and operations may be optional, combined into fewer steps and operations, or expanded into additional steps and operations without detracting from the essence of the disclosed embodiments.

FIG. 9 is a flow diagram illustrating a process 950 performed using a create SC module 112. The process 950 begins with Create Customized App 118 executes from Create SC Module 112, at operation 900. Create Customized App 118 inputs all data from the SC MFG Database 104, at operation 902. Create Customized App 118 determines the customized App design to be shipped to the user. For example, specifics about the user and EV profiles will be loaded into a platform App (not shown). This design data would be available to the user when using the Customized App at operation 904. Create Customized App 118 creates and uploads the Customized App for user use. For example, if the attribute(s) is 50% larger than the average supercapacitor, this data is used to customize the Customized App. For instance, the graphical user interface of the Customized APP (not shown) would should the updated attribute(s). Also, if other additions are made to the supercapacitor battery, such as sensors, the sensor reading, and displaying code are added to the customized App. Also, the specific SC CM Matrix Module for the supercapacitor is shipped code configured for the user to control (if needed to override) and display. This updated customized App is uploaded for the user to download and use in conjunction with driving the Electric Vehicle at operation 906. Create Customized App 118 saves all data to the SC MFG Database 104, at operation 908. Create Customized App 118 returns to the Create SC Module 112, at operation 910.

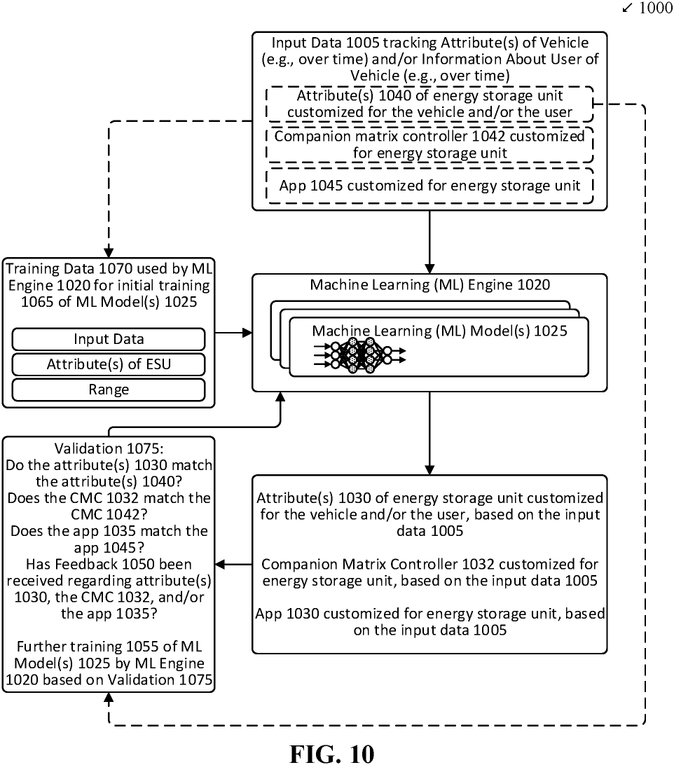

FIG. 10 is a block diagram 1000 illustrating use of one or more trained machine learning models 1025 of a machine learning engine 1020 to select attribute(s) 1030 of an energy storage unit (ESU) to customize the energy storage unit for a vehicle based on attribute(s) of the vehicle and information about a user of the vehicle (e.g., based on input data 1005). The ML engine 1020 and/or the ML model(s) 1025 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 10, a graphic representing the trained ML model(s) 1025 illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 1020 and/or the ML model(s) 1025 can be part of the AI/ML module 182.

Once trained via initial training 1065, the one or more ML models 1025 receive, as an input, input data 1005 that identifies attribute(s) of a vehicle (e.g., mileage, efficiency, ergonomics, aerodynamics, shape, geometry, weight, horsepower, brake power, turning radius, type, size, energy consumption rate, and the like) and/or information about a user of the vehicle (e.g., driving behavior type, level of riskiness in driving, history of speeding incidents, history of harsh braking incidents, history of swerving incidents, history of collisions and/or accidents, speed history, driving history, location history, movement history, velocity history, acceleration history, route history, user location/area, climate in user location/area, drive distance history, and the like). In some examples, the input data 1005 may be received from the user profile module 106 and/or the EV profile module 108, where the input data 1005 may be stored after measurement by various sensors of the vehicle. In some examples, for instance during validation 1075, the ML engine 1020 and/or the one or more ML models 1025 can also receive, as an additional input, a predetermined attribute(s) 1040 of the ESU that is based on (or otherwise corresponds to) the input data 1005. In some examples, for instance during validation 1075, the ML engine 1020 and/or the one or more ML models 1025 can also receive, as an additional input, a predetermined companion matrix controller 1042 for the vehicle and/or the ESU that is based on (or otherwise corresponds to) the input data 1005 and/or the predetermined attribute(s) 1040. In some examples, for instance during validation 1075, the ML engine 1020 and/or the one or more ML models 1025 can also receive, as an additional input, a predetermined software application 1045 for the vehicle and/or the ESU that is based on (or otherwise corresponds to) the input data 1005 and/or the predetermined attribute(s) 1040.

In response to receiving at least the input data 1005 as an input(s), the one or more ML model(s) 1025 select and/or otherwise determine attribute(s) 1030 for an energy storage unit (ESU) (e.g., type, voltage, discharge curve, capacitance, impedance, current, amperage, attribute(s), energy density, specific energy density, power density, temperature, temperature dependence, service life, physical attributes, charge cycle, discharge cycle, cycle life, deep discharge ability, discharge rate, charge rate, and the like). The ML model(s) 1025 select and/or otherwise determine the attribute(s) 1030 for the energy storage unit (ESU) so that the ESU is customized for the vehicle, for instance to optimize the ESU to align the optimal discharge rate of the ESU with the optimal power usage rate of the vehicle, to choose a ESU that is capable of operating in high or low heat depending on the climate that the user and/or vehicle will be in, to choose an ESU that does or does not tend to overheat depending on the heat dissipation capabilities of the vehicle and/or the predicted draw from the vehicle on the ESU, and the like. In some examples, the ML model(s) 1025 selects the attribute(s) 1030 for the energy storage unit (ESU) from a list of predetermined attribute options, the options for instance based on manufacturing capabilities of a manufacturer of the ESU.

In response to receiving at least the input data 1005, the estimated attribute(s) 1030, and/or the predetermined attribute(s) 1040 as an input(s), the ML model(s) 1025 can also generate and/or customize a companion matrix controller 1032 and/or a software application 1035 to be customized for the customized ESU, the vehicle, and/or the user. The companion matrix controller 1032 and/or the software application 1035 can be used by the user and/or the vehicle to control charging and/or discharging of the ESU within the context of the vehicle, and/or operation of the vehicle while powered by the ESU.

Selecting, determining, and/or generating the attribute(s) 1030, the companion matrix controller 1032, and/or the software application 1035 can correspond to at least operations 210, 602, 604, 606, 804, 806, 904, and/or 906. It should be understood that the pre-determined attribute(s) 1040, the pre-determined companion matrix controller 1042, and/or the pre-determined software application 1045 can likewise include any of the types of data listed above with respect to the attribute(s) 1030, the companion matrix controller 1032, and/or the software application 1035.

Once the one or more ML models 1025 generate the attribute(s) 1030, the companion matrix controller 1032, and/or the software application 1035 -the attribute(s) 1030, the companion matrix controller 1032, and/or the software application 1035 can be output to an output interface that can indicate the attribute(s) 1030, the companion matrix controller 1032, and/or the software application 1035. For instance, the output interface can send a request for the energy storage unit according to the attributes(s) 1030 of the energy storage unit using a communication interface. The request can be sent to an entity (e.g., a manufacturer, distributor, and/or merchant) to request that the entity make, select, and/or provide the customized ESU with the attribute(s) 1030 for the vehicle and/or the user. The output interface can display an indicator of the attributes(s) 1030 of the energy storage unit using a display, or play audio indicative of the attributes(s) 1030 of the energy storage unit. The output interface can provide the companion matrix controller 1032 and/or the software application 1035 to the user, the vehicle, and/or a repository to make the companion matrix controller 1032 and/or the software application 1035 available for download and/or use by the user, the vehicle, and/or a user device of the user.

Before using the one or more ML models 1025 to generate the attribute(s) 1030, the companion matrix controller 1032, and/or the software application 1035, the ML engine 1020 performs initial training 1065 of the one or more ML models 1025 using training data 1070. The training data 1070 can include examples of attribute data (e.g., as in the input data 1005) and/or examples of pre-determined companion matrix controller and/or the predetermined software application (e.g., as in the pre-determined attribute(s) 1040, the pre-determined companion matrix controller 1042, and/or the pre-determined software application 1045). In some examples, the pre-determined attribute(s), the pre-determined companion matrix controller, and/or the predetermined software application in the training data 1070 are previously generated by the one or more ML models 1025 based on the attribute data in the training data 1070. In the initial training 1065, the ML engine 1020 can form connections and/or weights based on the training data 1070, for instance between nodes of a neural network or another form of neural network. For instance, in the initial training 1065, the ML engine 1020 can be trained to output the pre-determined attribute(s), the pre-determined companion matrix controller, and/or the predetermined software application in the training data 1070 in response to receipt of the corresponding attribute data in the training data 1070.

During a validation 1075 of the initial training 1065 (and/or further training 1055), the input data 1005 (and/or the pre-determined attribute(s), the pre-determined companion matrix controller, and/or the predetermined software application in the training data 1070) is input into the one or more ML models 1025 to generate the attribute(s) 1030 as described above. The ML engine 1020 performs validation 1075 at least in part by determining whether the attribute(s) 1030 matches the pre-determined attribute(s) 1040 (and/or the pre-determined attribute(s) in the training data 1070), whether the companion matrix controller 1032 matches the pre-determined companion matrix controller 1042 (and/or the pre-determined companion matrix controller in the training data 1070), and/or whether the software application 1035 matches the pre-determined software application 1045 (and/or the pre-determined software application in the training data 1070).

If the attribute(s) 1030 match the pre-determined attribute(s) 1040 during validation 1075, then the ML engine 1020 performs further training 1055 of the one or more ML models 1025 by updating the one or more ML models 1025 to reinforce weights and/or connections within the one or more ML models 1025 that contributed to the generation of the attribute(s) 1030, encouraging the one or more ML models 1025 to generate similar attribute(s) given similar inputs. Similarly, if the companion matrix controller 1032 matches the pre-determined companion matrix controller 1042 during validation 1075, then the ML engine 1020 performs further training 1055 of the one or more ML models 1025 by updating the one or more ML models 1025 to reinforce weights and/or connections within the one or more ML models 1025 that contributed to the generation of the companion matrix controller 1032, encouraging the one or more ML models 1025 to generate similar companion matrix controller given similar inputs. Similarly, if the software application 1035 matches the pre-determined software application 1045 during validation 1075, then the ML engine 1020 performs further training 1055 of the one or more ML models 1025 by updating the one or more ML models 1025 to reinforce weights and/or connections within the one or more ML models 1025 that contributed to the generation of the software application 1035, encouraging the one or more ML models 1025 to generate similar software application given similar inputs.

If the attribute(s) 1030 does not match the pre-determined attribute(s) 1040 during validation 1075, then the ML engine 1020 performs further training 1055 of the one or more ML models 1025 by updating the one or more ML models 1025 to weaken, remove, and/or replace weights and/or connections within the one or more ML models that contributed to the generation of the attribute(s) 1030, discouraging the one or more ML models 1025 from generating similar attribute(s) given similar inputs. Similarly, if the companion matrix controller 1032 does not match the pre-determined companion matrix controller 1042 during validation 1075, then the ML engine 1020 performs further training 1055 of the one or more ML models 1025 by updating the one or more ML models 1025 to weaken, remove, and/or replace weights and/or connections within the one or more ML models that contributed to the generation of the companion matrix controller 1032, discouraging the one or more ML models 1025 from generating similar companion matrix controller given similar inputs. Similarly, if the software application 1035 does not match the pre-determined software application 1045 during validation 1075, then the ML engine 1020 performs further training 1055 of the one or more ML models 1025 by updating the one or more ML models 1025 to weaken, remove, and/or replace weights and/or connections within the one or more ML models that contributed to the generation of the software application 1035, discouraging the one or more ML models 1025 from generating similar software application given similar inputs.

Validation 1075 and further training 1055 of the one or more ML models 1025 can continue once the one or more ML models 1025 are in use based on feedback 1050 received regarding the attribute(s) 1030, the companion matrix controller 1032, and/or the software application 1035. In some examples, the feedback 1050 can be received from a user via a user interface, for instance via an input from the user interface that approves or declines use of the attribute(s) 1030, the companion matrix controller 1032, and/or the software application 1035. In some examples, the feedback 1050 can be received from another component or subsystem of the vehicle (e.g., an energy control system), for instance based on whether the component or subsystem successfully uses the attribute(s) 1030, the companion matrix controller 1032, and/or the software application 1035, whether use the attribute(s) 1030, the companion matrix controller 1032, and/or the software application 1035 causes any problems for the component or subsystem (e.g., which may be detected using the sensors), whether use the attribute(s) 1030, the companion matrix controller 1032, and/or the software application 1035 are accurate, or a combination thereof. If the feedback 1050 is positive (e.g., expresses, indicates, and/or suggests approval of the attribute(s) 1030, the companion matrix controller 1032, and/or the software application 1035, success of the attribute(s) 1030, the companion matrix controller 1032, and/or the software application 1035, and/or accuracy the attribute(s) 1030, the companion matrix controller 1032, and/or the software application 1035), then the ML engine 1020 performs further training 1055 of the one or more ML models 1025 by updating the one or more ML models 1025 to reinforce weights and/or connections within the one or more ML models 1025 that contributed to the generation of the attribute(s) 1030, the companion matrix controller 1032, and/or the software application 1035, encouraging the one or more ML models 1025 to generate similar attribute(s), companion matrix controller(s), and/or software application(s) given similar inputs. If the feedback 1050 is negative (e.g., expresses, indicates, and/or suggests disapproval of the attribute(s) 1030, the companion matrix controller 1032, and/or the software application 1035, failure of the attribute(s) 1030, the companion matrix controller 1032, and/or the software application 1035, and/or inaccuracy of the attribute(s) 1030, the companion matrix controller 1032, and/or the software application 1035) then the ML engine 430 performs further training 1055 of the one or more ML models 1025 by updating the one or more ML models 1025 to weaken, remove, and/or replace weights and/or connections within the one or more ML models that contributed to the generation of the attribute(s) 1030, the companion matrix controller 1032, and/or the software application 1035, discouraging the one or more ML models 1025 from generating similar attribute(s), companion matrix controller(s), and/or software application(s) given similar inputs.

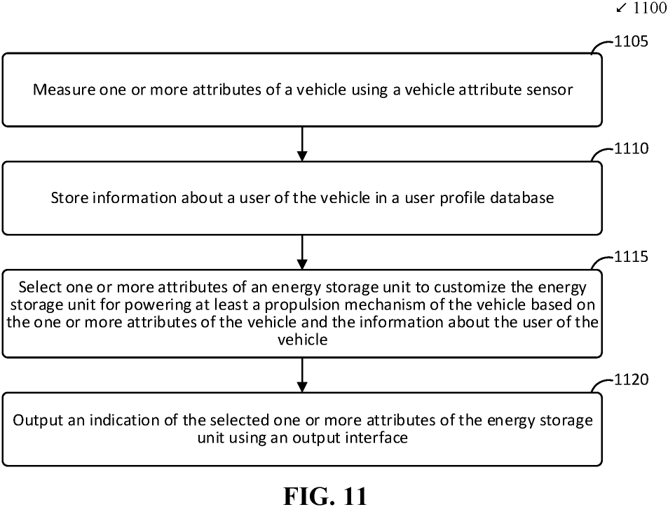

FIG. 11 is a flow diagram illustrating a process 1100 for vehicle energy architecture customization performed using a control system. The control system that performs the process 1100 can include the energy management system 100, the SC MFG base module 102, the supercapacitor unit 120, any system(s) that perform any of the processes of any of FIGS. 2-9, the ML engine 1020 of FIG. 10, an apparatus, a non-transitory computer-readable storage medium coupled to a processor, component(s) or subsystem(s) of any of these systems, or a combination thereof.

At operation 1105, the control system is configured to, and can, measure one or more attributes of a vehicle using a vehicle attribute sensor.

In some examples, the control system includes a vehicle management database that is configured to store data tracking the one or more attributes of the vehicle over time, wherein the control system is configured to select the one or more attributes of the energy storage unit to customize the energy storage unit for powering at least the propulsion mechanism of the vehicle based on the data tracking the one or more attributes of the vehicle over time and the information about the user of the vehicle.

At operation 1110, the control system is configured to, and can, store information about a user of the vehicle in a user profile database.

In some examples, the user profile database is configured to store data tracking the information about the user of the vehicle over time.

At operation 1115, the control system is configured to, and can, select one or more attributes of an energy storage unit to customize the energy storage unit for powering at least a propulsion mechanism of the vehicle based on the one or more attributes of the vehicle and the information about the user of the vehicle.

In some examples, the control system is configured to, and can, input the one or more attributes of the vehicle and the information about the user of the vehicle into a trained machine learning model to select the one or more attributes of the energy storage unit to customize the energy storage unit for powering at least the propulsion mechanism of the vehicle. In some examples, the control system is configured to, and can, input historical data tracking the one or more attributes of the vehicle over time and tracking the information about the user of the vehicle over time into the trained machine learning model to select the one or more attributes of the energy storage unit to customize the energy storage unit for powering at least the propulsion mechanism of the vehicle. In some examples, the control system is configured to, and can, use the selected one or more attributes of the energy storage unit as training data to update the trained machine learning model (e.g., as in the additional training 1055).

In some examples, the control system is configured to, and can, generate, based on the selected one or more attributes of the energy storage unit, a companion matrix controller that is customized for the energy storage unit. In some examples, the control system is configured to, and can, input the selected one or more attributes of the energy storage unit into a trained machine learning model to select the one or more attributes of the energy storage unit to generate the companion matrix controller that is customized for the energy storage unit.

In some examples, the control system is configured, and can, to generate, based on the one or more attributes of the vehicle and the information about the user of the vehicle, a companion matrix controller that is customized for the energy storage unit. In some examples, the control system is configured to, and can, input the one or more attributes of the vehicle and the information about the user of the vehicle into a trained machine learning model to select the one or more attributes of the energy storage unit to generate the companion matrix controller that is customized for the energy storage unit.

In some examples, the control system is configured to generate, based on the selected one or more attributes of the energy storage unit, a software application that is customized for controlling the energy storage unit. In some examples, the control system is configured, and can, input the selected one or more attributes of the energy storage unit into a trained machine learning model to select the one or more attributes of the energy storage unit to generate the companion matrix controller that is customized for the energy storage unit.

In some examples, the control system is configured to configure, based on the one or more attributes of the vehicle and the information about the user of the vehicle, a software application that is customized for controlling the energy storage unit. In some examples, the control system is configured, and can, input the one or more attributes of the vehicle and the information about the user of the vehicle into a trained machine learning model to select the one or more attributes of the energy storage unit to generate the companion matrix controller that is customized for the energy storage unit.

At operation 1120, the control system is configured to, and can, output an indication of the selected one or more attributes of the energy storage unit using an output interface.

In some examples, to output the indication, the output interface is configured to send a request for the energy storage unit according to the selected one or more attributes of the energy storage unit using a communication interface. In some examples, to output the indication, the output interface is configured to display the indication using a display.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Aspects of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, aspects of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A system for vehicle energy architecture customization, the system comprising:
a vehicle attribute sensor that is configured to measure one or more attributes of a vehicle;
a user profile database that is configured to store information about a user of the vehicle;
a control system comprising a processor with access to a memory, wherein the control system is configured to input the one or more attributes of the vehicle and the information about the user of the vehicle into a trained machine learning model to select one or more attributes of an energy storage unit to customize the energy storage unit for powering at least a propulsion mechanism of the vehicle based on the one or more attributes of the vehicle and the information about the user of the vehicle; and
an output interface coupled to the control system and configured to output an indication of the selected one or more attributes of the energy storage unit.

2. The system of claim 1, further comprising:
a vehicle management database that is configured to store data tracking the one or more attributes of the vehicle over time, wherein the control system is configured to select the one or more attributes of the energy storage unit to customize the energy storage unit for powering at least the propulsion mechanism of the vehicle based on the data tracking the one or more attributes of the vehicle over time and the information about the user of the vehicle.

3. The system of claim 1, wherein the user profile database is configured to store data tracking the information about the user of the vehicle over time.

4. (canceled)

5. The system of claim 1, wherein the control system is configured to also input historical data tracking the one or more attributes of the vehicle over time and tracking the information about the user of the vehicle over time into the trained machine learning model to select the one or more attributes of the energy storage unit to customize the energy storage unit for powering at least the propulsion mechanism of the vehicle.

6. The system of claim 1, wherein the control system is configured to use the selected one or more attributes of the energy storage unit as training data to update the trained machine learning model.

7. The system of claim 1, wherein the control system is configured to generate, based on the selected one or more attributes of the energy storage unit, a companion matrix controller that is customized for the energy storage unit.

8. The system of claim 7, wherein the control system is configured to input the selected one or more attributes of the energy storage unit into a second trained machine learning model to select the one or more attributes of the energy storage unit to generate the companion matrix controller that is customized for the energy storage unit.

9. The system of claim 1, wherein the control system is configured to generate, based on the selected one or more attributes of the energy storage unit, a software application that is customized for controlling the energy storage unit.

10. The system of claim 9, wherein the control system is configured to input the selected one or more attributes of the energy storage unit into a second trained machine learning model to select the one or more attributes of the energy storage unit to generate the software application that is customized for the energy storage unit.

11. The system of claim 1, wherein the control system is configured to generate, based on the one or more attributes of the vehicle and the information about the user of the vehicle, a companion matrix controller that is customized for the energy storage unit.

12. The system of claim 1, wherein the control system is configured to configure, based on the one or more attributes of the vehicle and the information about the user of the vehicle, a software application that is customized for controlling the energy storage unit.

13. The system of claim 1, wherein, to output the indication, the output interface is configured to send a request for the energy storage unit according to the selected one or more attributes of the energy storage unit using a communication interface.

14. The system of claim 1, wherein, to output the indication, the output interface is configured to display the indication using a display.

15. A method for vehicle energy architecture customization, the method comprising:
measuring one or more attributes of a vehicle using a vehicle attribute sensor;
storing information about a user of the vehicle in a user profile database;
inputting the one or more attributes of the vehicle and the information about the user of the vehicle into a trained machine learning model to select one or more attributes of an energy storage unit to customize the energy storage unit for powering at least a propulsion mechanism of the vehicle based on the one or more attributes of the vehicle and the information about the user of the vehicle; and
outputting an indication of the selected one or more attributes of the energy storage unit using an output interface.

16. (canceled)

17. The method of claim 15, further comprising using the selected one or more attributes of the energy storage unit as training data to update the trained machine learning model.

18. The method of claim 15, further comprising generating, based on the selected one or more attributes of the energy storage unit, a companion matrix controller that is customized for the energy storage unit.

19. The method of claim 15, wherein outputting the indication includes sending a request for the energy storage unit according to the selected one or more attributes of the energy storage unit using a communication interface.

20. A non-transitory computer readable storage medium having embodied thereon a program, wherein the program is executable by a processor to perform a method of energy architecture customization, the method comprising:
measuring one or more attributes of a vehicle using a vehicle attribute sensor;
storing information about a user of the vehicle in a user profile database;
inputting the one or more attributes of the vehicle and the information about the user of the vehicle into a trained machine learning model to select one or more attributes of an energy storage unit to customize the energy storage unit for powering at least a propulsion mechanism of the vehicle based on the one or more attributes of the vehicle and the information about the user of the vehicle; and
outputting an indication of the selected one or more attributes of the energy storage unit using an output interface.
